(19) United States
(12) Patent Application Publication
(10) Pub. No.: US 2019/0333160 A1
(43) Pub. Date: Oct. 31, 2019

(54) METHOD FOR PRINTING A REDEEMABLE CHECK AND METHOD FOR CONNECTING INFORMATION OF A REDEEMABLE CHECK BETWEEN A PAYER AND AN ACCOUNTANT

(71) Applicant: Taxcom Inc, City of Industry, CA (US)

(72) Inventor: Zishun Michael Chen, City of Industry, CA (US)

(21) Appl. No.: 16/396,560

(22) Filed: Apr. 26, 2019

Related U.S. Application Data
(60) Provisional application No. 62/663,475, filed on Apr. 27, 2018.

(51) Int. Cl. G06Q 40/00; G06Q 20/04

(52) U.S. Cl. CPC G06Q 40/128; G06Q 20/042

(57) ABSTRACT

A method for printing a redeemable check, comprising: setting a payer information in a printer; entering an amount of payment, a date and a receiver in printer; and printing redeemable check via printer. A method for connecting information of a redeemable check between a payer and an accountant, comprising: setting a payer information; entering an amount of payment, a date and a receiver; sending information of redeemable check to a cloud database; authorizing an accountant to review redeemable check via cloud database by a payer; checking receiver information by accountant; and receiver receiving redeemable check from accountant. A method for connecting information of a redeemable check between a payer and an accountant, comprising: taking a picture of redeemable check by payer; sending picture of redeemable check to a cloud database; authorizing an accountant to review redeemable check via cloud database by a payer; and checking receiver information by accountant.

### CROSS-REFERENCE TO RELATED APPLICATION

This application claims the priority of provisional patent application U.S. Ser. No. 62/663,475 filed Apr. 27, 2018 which is expressly incorporated by reference herein in its entirety.

### TECHNICAL FIELD OF THE INVENTION

The present application generally relates to a checking system method, and more particularly, to a method for printing a redeemable checking and a method for connecting information of a redeemable check between a payer and an accountant.

### BACKGROUND OF THE INVENTION

Generally, taxpayers, especially small business taxpayers, will be asked for the purpose of paid checks when their accountants perform bookkeeping services for them at year end. At this moment, the taxpayers may need to find out the historical documents such as check books and then submit to the accountant. However, this process is easy to have trouble since the taxpayers may miss or lost the historical documents or the account may make mistakes when reviewing the information one by one. In addition, it is also time consuming for both parties to search, check, review and confirm for every historical documents.

Furthermore, it is also common for the payer to make mistakes accidentally when writing the information and signing on the check.

Therefore, a need remains for a method for printing a redeemable checking and a method for connecting information of a redeemable check between a payer and an accountant to provide a more accurate and more efficient way for both taxpayers and the accountant.

### SUMMARY OF THE INVENTION

The present application discloses a method for printing a redeemable checking and a method for connecting information of a redeemable check between a payer and an accountant to provide a more accurate and more efficient way for both taxpayers and the accountant.

A method for printing a redeemable check, comprising: setting a payer information in a printer; entering an amount of payment, a date and a receiver in the printer; and printing the redeemable check via the printer. The step of setting the payer information in the printer comprises: setting a payer e-signature; and setting a payer routing number and a payer account number.

In various exemplary embodiments, before setting the payer information in the printer, the method further comprises selecting a desired bank account.

In various exemplary embodiments, before entering the amount of payment, the date and the receiver in the printer, the method further comprises entering a memo.

In various exemplary embodiments, after entering the amount of payment, the date and the receiver in the printer, the method further comprises entering a memo.

According to an exemplary embodiment of the method for printing the redeemable check, after printing the redeemable check via the printer, the method further comprises: sending information of the redeemable check to a cloud database; authorizing an accountant to review the redeemable check via the cloud database by a payer; and checking receiver information by the accountant. In addition, before or after checking the receiver information by the accountant, the method may further comprises providing the redeemable check to the receiver.

According to the other exemplary embodiment, a step of printing the redeemable check via the printer comprises: sending information of the redeemable check to a cloud database at a real time; authorizing an accountant to review the redeemable check via the cloud database by a payer; checking receiver information by the accountant; and providing the redeemable check to the receiver by the accountant.

The present application also discloses a method for connecting information of a redeemable check between a payer and an accountant, comprising: setting a payer information; entering an amount of payment, a date and a receiver; sending information of the redeemable check to a cloud database; authorizing the accountant to review the redeemable check via the cloud database by the payer; checking receiver information by the accountant; and the receiver receiving the redeemable check from the accountant. The step of setting the payer information comprises setting a payer e-signature; and setting a payer routing number and a payer account number.

In various exemplary embodiments, before setting the payer information, the method further comprises selecting a desired bank.

In various exemplary embodiments, before entering the amount of payment, the date and the receiver, the method further comprises entering a memo.

In various exemplary embodiments, after entering the amount of payment, the date and the receiver, the method further comprises entering a memo.

In various exemplary embodiments, a step of sending the information of the redeemable check to the cloud database comprises sending a receiver address to the cloud database.

The present application also discloses another method for connecting information of a redeemable check between a payer and an accountant, comprising: taking a picture of the redeemable check by the payer; sending the picture of the redeemable check to a cloud database; authorizing the accountant to review the redeemable check via the cloud database by the payer; and checking receiver information by the accountant.

According to an exemplary embodiment of the method for connecting the information of the redeemable check between the payer and the accountant, after sending the picture of the redeemable check to the cloud database, the method further comprises: providing the redeemable check to the receiver; and redeeming the redeemable check by the receiver.

According to the other exemplary embodiment, before sending the picture of the redeemable check to the cloud database, the method further comprises: providing the redeemable check to the receiver; and redeeming the redeemable check by the receiver.

Based on the above, the present application allows the payer and the accountant connect the information more efficiently and more accurately since the accountant can receive the checking documents right after the payer send the redeemable check information to the cloud database. In addition, the printer may print the redeemable check directly, reducing the likelihood of making the mistakes when writing information or signing.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 illustrates a view of an exemplary system for printing a redeemable check.

FIG. 2A illustrates a flow chart of a method for printing the redeemable check.

FIG. 2B illustrates another flow chart of a method for printing the redeemable check.

FIG. 3 illustrates a view of a first exemplary system for connecting information of a redeemable check between a payer and an accountant.

FIG. 4 illustrates a flow chart of a method for connecting the information of the redeemable check between the payer and the accountant of the first exemplary system.

FIG. 5 illustrates a view of a second exemplary system for connecting information of a redeemable check between a payer and an accountant.

FIG. 6 illustrates a flow chart of a method for connecting the information of the redeemable check between the payer and the accountant of the second exemplary system.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

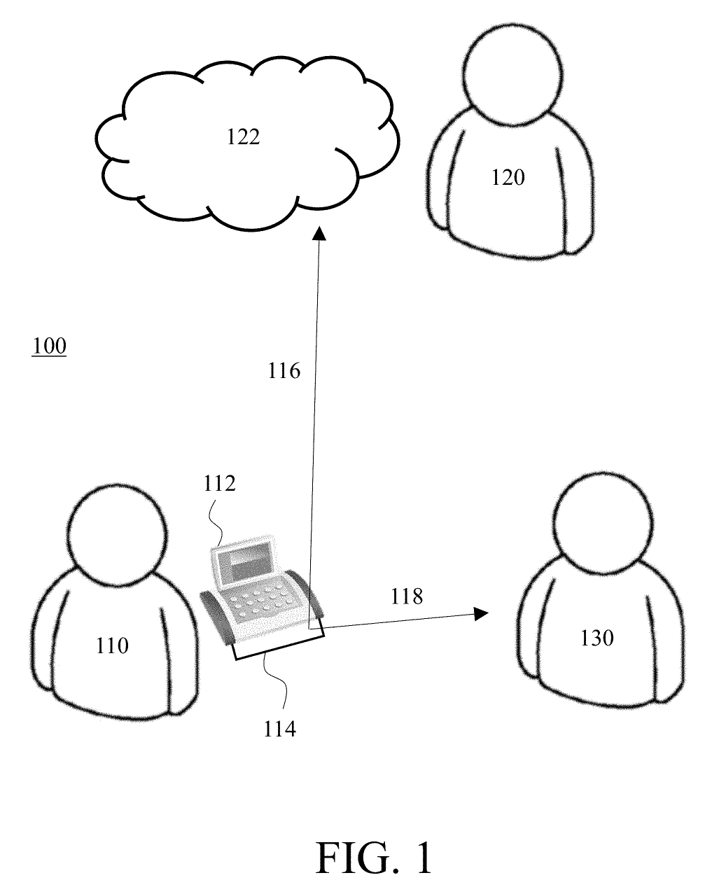

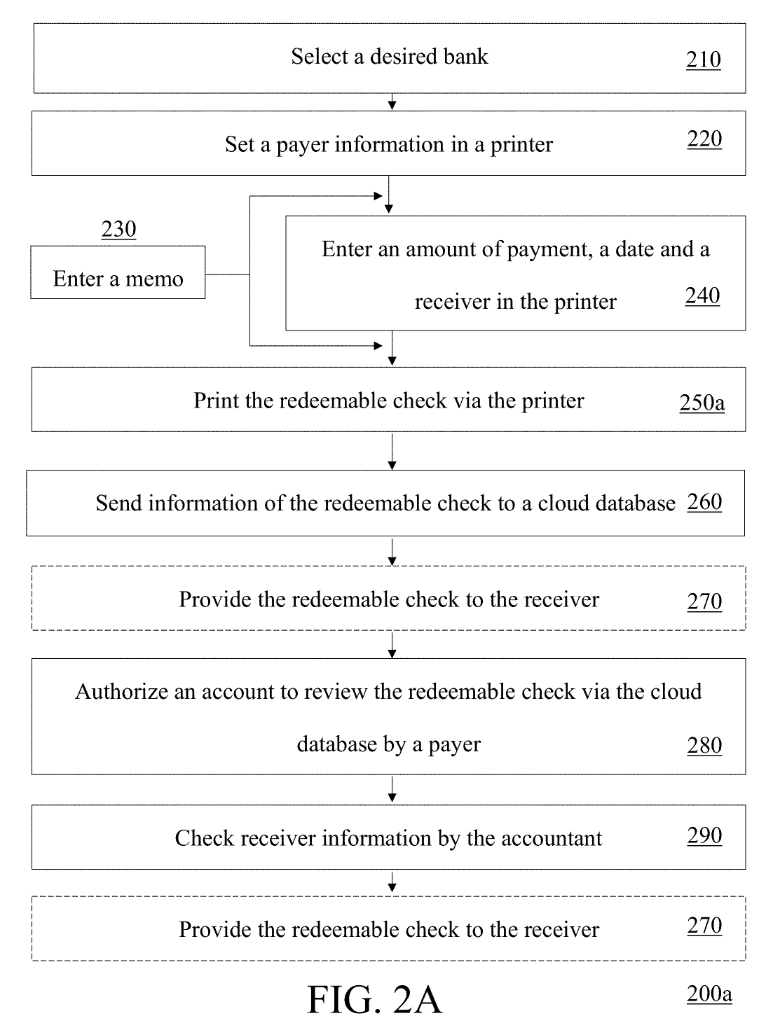

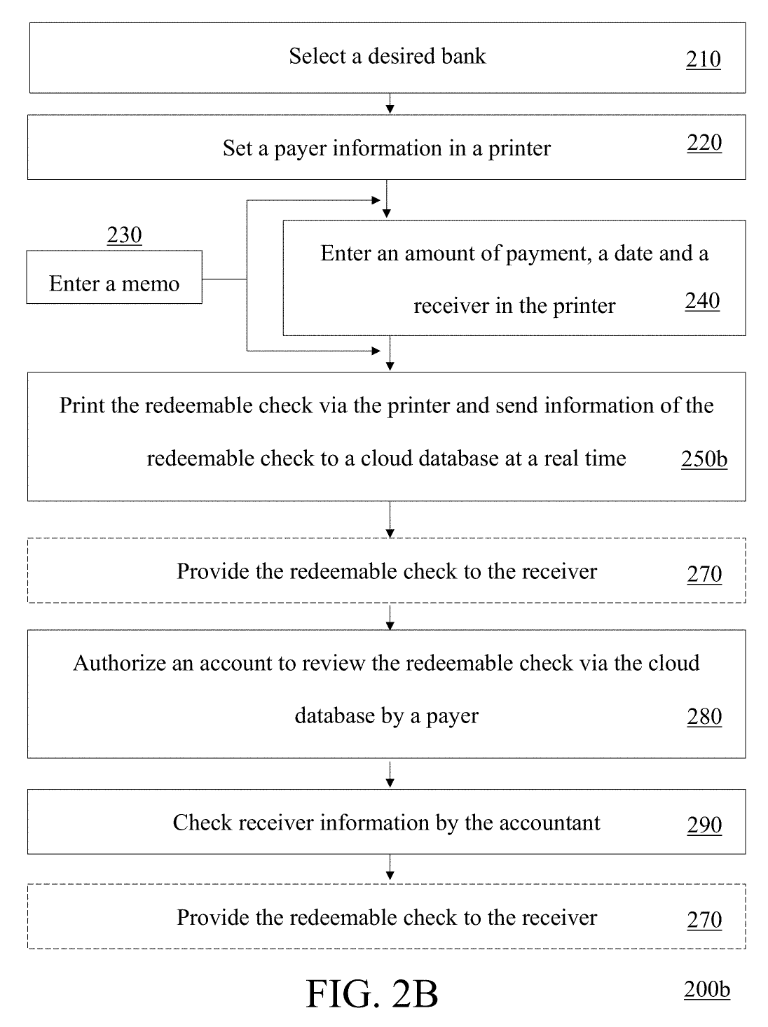

FIG. 1 illustrates a view of an exemplary system 100 for printing a redeemable check. FIG. 2A illustrates a flow chart of a method 200a for printing the redeemable check.

Referring to FIG. 1, the system 100 comprises a payer 110, an accountant 120 and a receiver 130. The payer 110 can print out a redeemable check 114 via a printer 112. Referring to FIGS. 1-2A, at the beginning step 210, the payer 210 may select a desired bank to pay the redeemable check 114. Next, as shown in step 220, then setting a payer information in the printer 112. Specifically, the step 220 comprises setting a payer e-signature and setting a payer routing number and a payer account number. The payer and payer bank information is transmitted to a cloud database (RDMS, relational database system such as Postgres) via the Internet http SSL protocol. The present application uses a cloud database such as Amazon AWS infrastructure. By doing so, the payer 110 may not need to sign or enter his/her personal information every time. The printer may store the information for the next time, allowing the payer 110 to get rid of the process of drafting the personal information and signing.

As shown in step 240, the payer 110 then can enter an amount of payment, a date and a receiver in the printer 112. In addition, the payer may also enter a memo before or after the step 240 as shown in step 230. After that, the redeemable check 114 may be printed via the printer 112 as shown in step 250a.

As shown in step 260 and arrow 116, then sending the information of the redeemable check 114 to a cloud database 122. The payer 110 and receiver 130, amount of payment, memo and timestamp etc. are transmitted and stored in a cloud database. The web application is implemented in a programming language named Python with Django framework. Note the web application is not limited to any specific language. The web application is accessible via a browser (such as Internet Explorer, Google Chrome etc).

Referring to step 270, the payer 110 then provides the redeemable check 114 to the receiver 130 for redeeming as shown by arrow 118. In step 280, payer 110 may authorize the accountant 120 to download the check transaction data via the cloud database 122. Note payer 110 may decide to authorize the data to be viewable to the accountant 120 after payer has obtained a business relationship with the accountant 120. After step 280, the accountant 120 may receive the notice of redemption for reviewing and checking receiver information as shown in step 290, making sure whether the person is correct. The data can be used for bookkeeping purpose for the payer 110.

It should be noted that as shown in step 270, the payer 110 may provide the redeemable check to the receiver 130 before the accountant 290 checking receiver information. As such, the accountant 120 may confirm every information beforehand.

FIG. 2B illustrates another flow chart of a method 200b for printing the redeemable check.

Referring to FIGS. 1-2B, the difference between the method 200a and the method 200b is that there is no pre-existing payer/accountant relationship in 200a but there is existing payer/accountant relationship in 200b. As such, in method 200b, the check data is sent to the accountant 120 in real time in step 250b. Specifically, the accountant 120 may review the information of the redeemable check 114 after receiving the information, making the process of filing tax refund more easily. After the accountant 120 logs into the web application with a username and password, the accountant 120 can view the related information in a web browser.

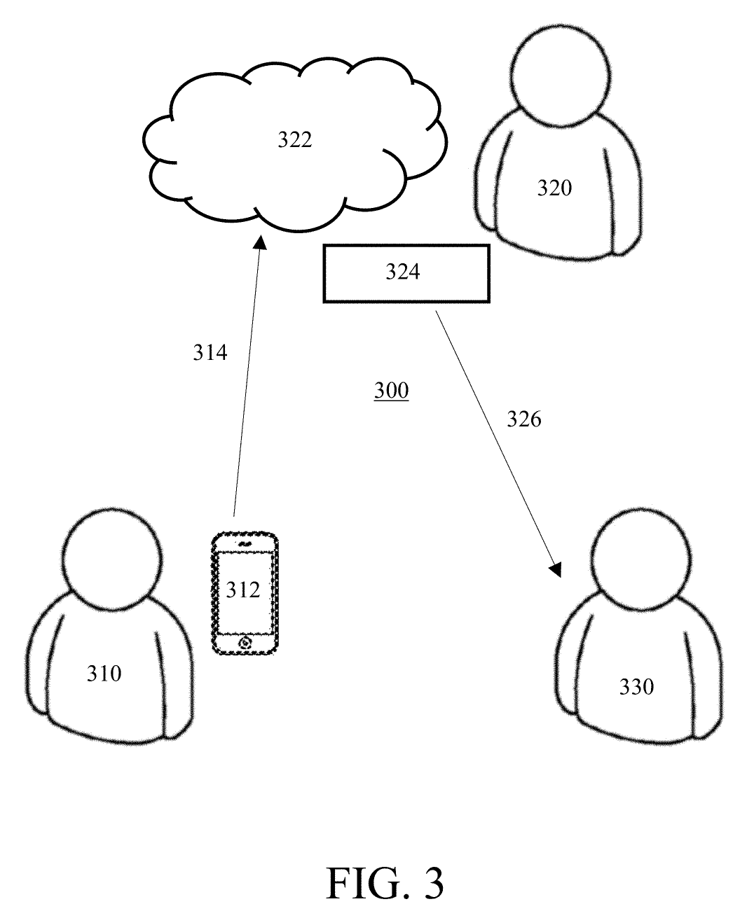

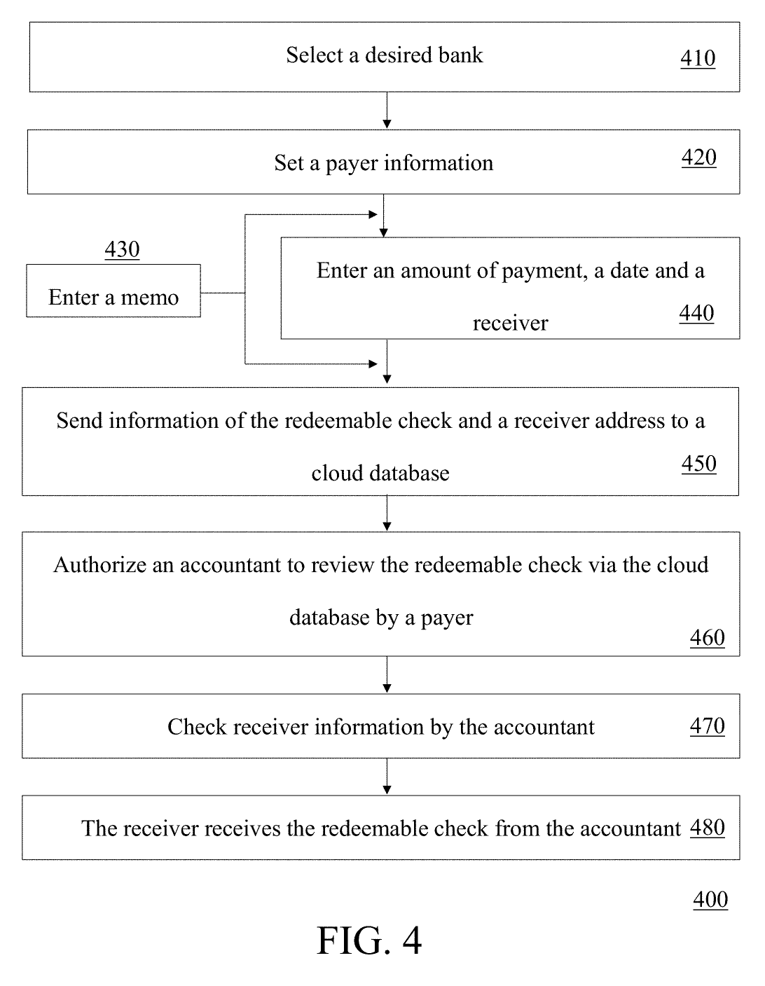

FIG. 3 illustrates a view of a first exemplary system 300 for connecting information of a redeemable check 324 between a payer 310 and an accountant 320. FIG. 4 illustrates a flow chart of a method 400 for connecting the information of the redeemable check 324 between the payer 310 and the accountant 320 of the first exemplary system 300.

The system 300 involves a payer 310, an accountant 320 and a receiver 330. The payer 310 can enter information of a redeemable check 324 via an app 312 in a mobile phone. Payer app is an Apple ios or Google Android App. The App is available publicly in Apple App store or Google Play. However, the payer 310 has to login with authorized user name and password. Referring to FIGS. 3-4, at the beginning step 410, the payer 310 may select a desired bank to pay the redeemable check 324. Next, as shown in step 420, then setting a payer information in the app 312. Specifically, the step 420 comprises setting a payer e-signature and setting a payer routing number and a user account number. By doing so, the payer 310 may not need to sign or enter his/her personal information every time. The app 312 may store the information for the next time, allowing the payer 310 to get rid of the process of drafting the personal information and signing. As payer signature and payment information are stored in the cloud database 322. Upon authorization by the payer 310, the accountant 320 can create checks with payer signature projected in check 324 and pay the receivers on behalf of the payer 310 without payer 310 physically sign checks every time. System 300 will send notification (email/text) to payer about every transaction. Further, all records can be viewed by corresponding parties in a web browser. This embodiment makes it easy to store, search and audit business transactions.

To overlay payer signature to a check, it is required to transform the image of the original payer signature to the check image. Assuming that the original coordinates are (X, Y) in the payer signature image, the scaling factors are (S_{X}, S_{Y}), and the produced coordinates in the check image are (X′, Y′). The math equation may be represented as shown below:

X′=X·S_{X} and Y′=Y·S_{Y}

The scaling factor S_{X}, S_{Y} scales the payer signature in X and Y direction respectively. The above equations can also be represented in matrix form as follows:

$$( \begin{matrix}{X}^{′} \\ {Y}^{′}\end{matrix} ) = ( \begin{matrix}X \\ Y\end{matrix} ) [ \begin{matrix}{S}_{x} & 0 \\ 0 & {S}_{y}\end{matrix} ]$$

As shown in step 440, the payer 310 then can enter an amount of payment, a date and a receiver in the app 312. In addition, the payer may also enter a memo before or after the step 440 as shown in step 430.

After that, the payer 310 may click the send button in the app 312 to send the information of the redeemable check 324 to the cloud database 322 for the accountant 320 as shown in step 450 and arrow 314. In addition, the payer 310 may also send the receiver 330 address for the accountant 320 if needed.

Referring to step 460, the accountant 320 then may check and review the receiver 330 information and the address, and then send the redeemable check 324 to the receiver 324 after confirmation as shown by arrow 326. Specifically, the payer 310 may authorize the accountant 320 to review the redeemable check via the cloud database 322. After that, the accountant 320 may check the receiver 330 information as shown in step 470.

In this embodiment, the accountant 320 prints the check 324 and sends the receiver 330 the check 324. Payer 310 is typically small business owner and time is very limited. The present application can save payer 310 a lot of time and money to paying his receivers/vendors by engaging an accountant 320 to pay the check 324 to receivers 330. In addition, since the check 324 is prepared by the accountant 320, the problem of providing a wrong check 324 can be reduced. Furthermore, the check 324 information related to tax matter may also be updated in real time.

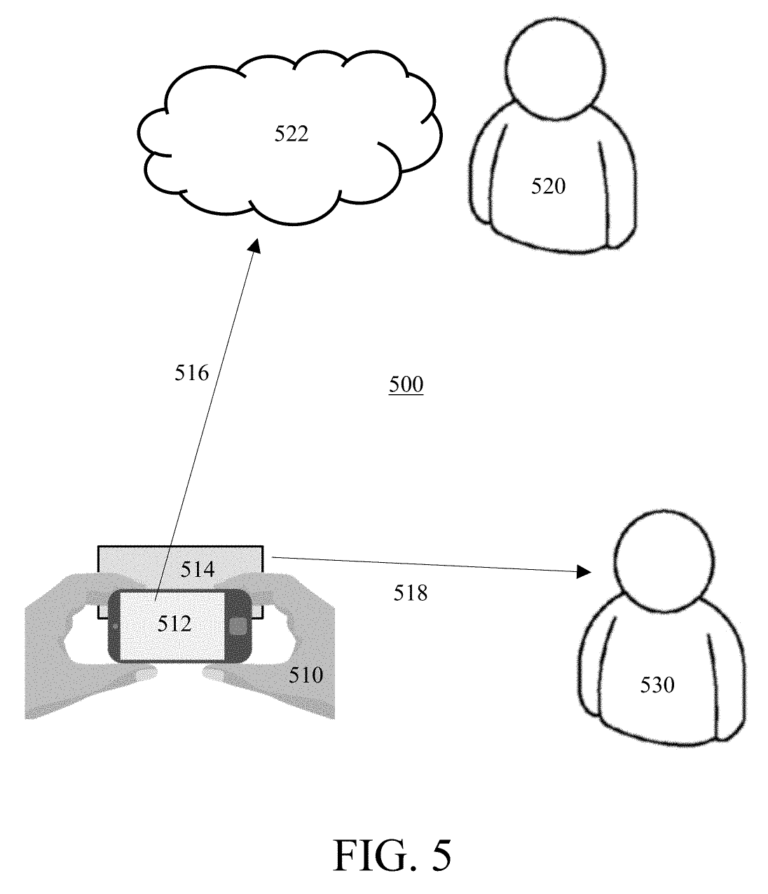

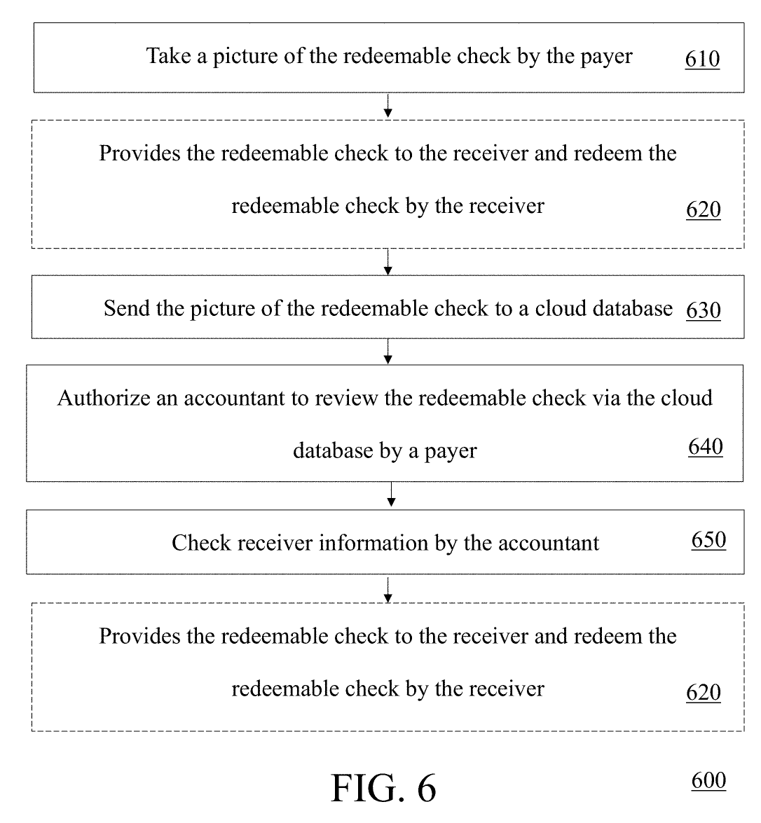

FIG. 5 illustrates a view of a second exemplary system 500 for connecting information of a redeemable check 514 between a payer 510 and an accountant 520. FIG. 6 illustrates a flow chart of a method 600 for connecting the information of the redeemable check 514 between the payer 510 and the accountant 530 of the second exemplary system 500.

Referring to FIG. 5, the system 500 involves a payer 510, an accountant 520 and a receiver 530. After drafting the redeemable check 514, the payer 510 may take a picture 512 of the redeemable check 514 and send the picture 512 to the cloud database 522 for the accountant 510 as shown in step 630 and arrow 516.

As shown in arrow 518, it should be noted that the payer 510 may provide the redeemable check 514 to the receiver 530 and the receiver 530 may redeem the redeemable check 514 after receiving before or after the payer 510 send the picture of the redeemable check 514 to the cloud database 522. The present application is not limited to the time for providing the redeemable check 514 to the receiver 530.

In this embodiment, the payer 510 does not have to enter the information as he can take a picture of the check 514 instead. The picture is uploaded to cloud database 522 and the information may be extracted by OCR (Optical Character Recognition). Therefore, the accountant 510 may receive the information of the redeemable check 514 more efficiently.

After sending the picture of the redeemable check 514 to the cloud database 522, the accountant 520 may receive the notice of redemption for checking and reviewing receiver information as shown in step 650. The authorized accountant 520 can view the check images and extracted OCR information. Based on this information, the accountant 520 can perform the bookkeeping, tax filing functions for the payer/business owner.

Based on the above, the present application allows the payer and the accountant connect the information more efficiently and more accurately since the accountant can receive the checking documents right after the payer send the redeemable check information to the cloud database. In addition, the printer may print the redeemable check directly, reducing the likelihood of making the mistakes when writing information or signing.

It will be apparent to those skilled in the art that various modifications and variations can be made to the structure of the present application without departing from the scope or spirit of the present application. The application is not limited to accountants and it is also applicable to other professionals such as lawyers, marketers, real estate agents etc. In view of the foregoing, it is intended that the present application cover modifications and variations of this application provided they fall within the scope of the following claims and their equivalents.

What is claimed is:

1. A method for printing a redeemable check, comprising:
setting a payer information in a printer, comprising:
setting a payer e-signature; and
setting a payer routing number and a payer account number;
entering an amount of payment, a date and a receiver in the printer; and
printing the redeemable check via the printer.

2. The method for printing the redeemable check as claimed in claim 1, wherein before setting the payer information in the printer, the method further comprises selecting a desired bank account.

3. The method for printing the redeemable check as claimed in claim 1, wherein before entering the amount of payment, the date and the receiver in the printer, the method further comprises entering a memo.

4. The method for printing the redeemable check as claimed in claim 1, wherein after entering the amount of payment, the date and the receiver in the printer, the method further comprises entering a memo.

5. The method for printing the redeemable check as claimed in claim 1, wherein after printing the redeemable check via the printer, the method further comprises sending information of the redeemable check to a cloud database.

6. The method for printing the redeemable check as claimed in claim 5, wherein after sending information of the redeemable check to the cloud database, the method further comprises:
authorizing an accountant to review the redeemable check via the cloud database by a payer; and
checking receiver information by the accountant.

7. The method for printing the redeemable check as claimed in claim 6, wherein after checking receiver information by the accountant, the method further comprises providing the redeemable check to the receiver.

8. The method for printing the redeemable check as claimed in claim 6, wherein before checking receiver information by the accountant, the method further comprises providing the redeemable check to the receiver.

9. The method for printing the redeemable check as claimed in claim 1, wherein a step of printing the redeemable check via the printer comprises sending information of the redeemable check to a cloud database at a real time.

10. The method for printing the redeemable check as claimed in claim 9, wherein after sending the information of the redeemable check to the cloud database at a real time, the method further comprises:
authorizing an accountant to review the redeemable check via the cloud database by a payer; and
checking receiver information by the accountant.

11. The method for printing the redeemable check as claimed in claim 10, wherein after checking the receiver information by the accountant, the method further comprises providing the redeemable check to the receiver by the accountant.

12. A method for connecting information of a redeemable check between a payer and an accountant, comprising:
setting a payer information, comprising:
setting a payer e-signature; and
setting a payer routing number and a payer account number;
entering an amount of payment, a date and a receiver;
sending information of the redeemable check to a cloud database;
authorizing the accountant to review the redeemable check via the cloud database by the payer;
checking receiver information by the accountant; and
the receiver receiving the redeemable check from the accountant.

13. The method for connecting the information of the redeemable check between the payer and the accountant as claimed in claim 12, wherein before setting the payer information, the method further comprises selecting a desired bank.

14. The method for connecting the information of the redeemable check between the payer and the accountant as claimed in claim 12, wherein before entering the amount of payment, the date and the receiver, the method further comprises entering a memo.

15. The method for connecting the information of the redeemable check between the payer and the accountant as claimed in claim 12, wherein after entering the amount of payment, the date and the receiver, the method further comprises entering a memo.

16. The method for connecting the information of the redeemable check between the payer and the accountant as claimed in claim 12, wherein a step of sending the information of the redeemable check to the cloud database comprises sending a receiver address to the cloud database.

17. A method for connecting information of a redeemable check between a payer and an accountant, comprising:
taking a picture of the redeemable check by the payer; and
sending the picture of the redeemable check to a cloud database;
authorizing the accountant to review the redeemable check via the cloud database by the payer; and
checking receiver information by the accountant.

18. The method for connecting the information of the redeemable check between the payer and the accountant as claimed in claim 17, wherein after sending the picture of the redeemable check to the cloud database, the method further comprises:
providing the redeemable check to the receiver; and
redeeming the redeemable check by the receiver.

19. The method for connecting the information of the redeemable check between the payer and the accountant as claimed in claim 17, wherein before sending the picture of the redeemable check to the cloud database, the method further comprises:
providing the redeemable check to the receiver; and
redeeming the redeemable check by the receiver.
